(19) United States
(12) Patent Application Publication
(10) Pub. No.: US 2009/0236034 A1
(43) Pub. Date: Sep. 24, 2009

(54) FILM FOR TRANSFERRING AT LEAST ONE MARK ON AT LEAST ONE SUBSTRATE TO BE MADE SECURE, METHOD FOR MAKING AND FOR TRANSFERRING SUCH A TRANSFER FILM

(76) Inventors: Jean-Yves Leroy, Restinclieres (FR); Francois Trantoul, Lunel (FR)

Correspondence Address: YOUNG & THOMPSON, 209 Madison Street, Suite 500, ALEXANDRIA, VA, 22314, US

(21) Appl. No.: 12/279,342

(22) PCT Filed: Jan. 29, 2007
(86) PCT No.: PCT/FR07/00164

§ 371 Date: Aug. 14, 2008

(30) Foreign Application Priority Data
Feb. 23, 2006 (FR) 0601583

(51) Int. Cl. B44C 1/16; B32B 3/10; B44F 1/08; B32B 29/00; B05D 1/36

(52) U.S. Cl. 156/230; 428/195.1; 428/29; 428/211.1; 427/402

(57) ABSTRACT

The invention concerns a method and a film for transferring at least one mark on a substrate (10), each mark comprising an embossed and/or metallized pattern, said transfer film including a base film (1), a multilayer film supported by said base film (1), and comprising an optical layer (5), including an embossed and/or metallized image, a releasing layer (2) arranged between said base film (1) and said multilayer film (9) for enabling, during a transfer, said film (1) to be detached from said multilayer film (9), an adhesive layer (7) arranged opposite said releasing layer. The invention is characterized in that the adhesive film (7) extends according to a format and dimensions smaller than those of the multilayer film (9) such that only the portions of the multilayer film opposite the adhesive layer (7), and which define each mark to be transferred, are transferable onto said substrate (10), for each mark, a portion of the adhesive layer is arranged opposite a portion of the embossed and/or metallized pattern forming a pattern of said mark.

The invention concerns a film for transferring at least one mark to be transferred onto at least one substrate to be made secure, a method for making such a transfer film and a transfer method.

A film for transferring at least one mark onto at least one substrate is used in particular to protect documents such as identity cards, passports, credit cards, cheques, banknotes, transport tickets, entry tickets, cards giving an entitlement to various services, etc.

Such a transfer film preferably includes a multilayer film, carrying as a mark at least one optical authentication component such as a hologram, a diffraction grating, miniature Fresnel mirrors, etc., formed of an embossed and/or metallized image.

A multilayer transfer film, particularly a multilayer optical film, thus typically includes at least one layer, a so-called optical layer, including at least one embossed and/or metallized image in such a way that a transfer operation performed with this transfer film allows the authentication mark to be transferred onto the document to be protected. This mark then allows fast and reliable visual inspection of the document for the purposes of ensuring its authenticity.

U.S. Pat. No. 5,104,471 describes a transfer film that includes a base film carrying at least one label equipped with a layer forming optical diffraction embossing structures interposed between two layers of protection varnish, an adhesive layer, a stabilization layer and a base film releasing layer. Each label of this transfer film is transferable by hot rolling onto a substrate to be protected. Each label must be associated with the base film and sized particularly by being kiss-cut (in only one part of the thickness without cutting the base film) or by being cut and then bonded onto a specific base film.

Such a solution allows a thick transfer film to be made, particularly a transfer film of over 50 microns which can be easily manipulated during transfer operations onto a substrate to be protected. On the other hand, preparatory work is required to size each label to be transferred which includes in particular a kiss-cutting step followed by a trimming step.

Such a transfer film therefore takes a relatively long time to make, requires specific tools and entails relatively high manufacturing costs.

FR 2 535 864 describes a multilayer transfer film that includes a base film, a non-stick layer, an optical component of the hologram type forming at least one mark to be transferred onto a substrate to be made secure, onto which an adhesive layer is affixed. To transfer this film onto a substrate, an application plate is used to compress the film against the substrate to be made secure. This causes adhesion to the substrate and separation from the base film due to the fusion of the non-stick layer. This adhesion and this separation only occur in the areas located underneath and opposite the pressure application plate.

That being the case, such a multilayer transfer film can be used only with a specific application plate whose dimensions exactly match the dimensions of the optical component forming the mark to be transferred. There must therefore be a specific application plate that matches each form of optical component forming the mark to be transferred. Moreover, the plate must be accurately positioned exactly vertical to the portion of the optical component forming the mark to be transferred; otherwise the required areas of the optical component will not be transferred. It is therefore necessary to use a specific system for positioning the application plate opposite the transfer film. Furthermore, since manufacturing such a plate is expensive, such a transfer film does not allow a document to be made secure in a cost-effective, fast and reliable way.

The aim of the invention is a multilayer transfer film that can overcome all these drawbacks.

The aim of the invention is a thick film for transferring at least one mark onto at least one substrate which requires no prior cutting, particularly kiss-cutting, of one or more layers according to the format of the mark to be transferred.

The aim of the invention is a multilayer film for transferring a mark, the transfer of which does not require a specific press for applying the film to a substrate to be made secure.

The aim of the invention is a multilayer film for transferring a mark particularly adapted for transferring a mark that includes at least one embossed and/or metallized layer, particularly a holographic layer.

The aim of the invention is a film for transferring at least one mark onto at least one substrate, which transfer can be performed in a straightforward and effective way by an operator.

Another aim of the invention is a method for making a thick transfer film that can overcome the drawbacks of prior art transfer films.

Another aim of the invention is a method for transferring at least one mark onto at least one substrate to be made secure.

To do this, the invention concerns a film for transferring at least one mark to be transferred onto at least one substrate to be made secure, each mark to be transferred including at least one embossed and/or metallized pattern, this transfer film including:
a base film,
a multilayer film carried by said base film, and including at least one layer, a so-called optical layer, including at least one embossed and/or metallized image,
a releasing layer arranged between said base film and said multilayer film for enabling, during a transfer, the base film to be detached from the multilayer film,
an adhesive layer arranged on the opposite side from said releasing layer,
   wherein:
the adhesive layer extends opposite at least one portion of the multilayer film according to a format and dimensions smaller than those of the multilayer film and defines each mark to be transferred onto said substrate,
each portion of the multilayer film opposite the adhesive layer is adapted so as to separate itself, during a transfer, from the adjacent portions of the multilayer film which are not opposite the adhesive layer,
for each mark to be transferred so defined, at least one portion of the adhesive layer is arranged opposite at least one portion of at least one embossed and/or metallized image of said optical layer, each image portion forming a pattern of this mark to be transferred onto said substrate.

An adhesive layer arranged exactly opposite a portion of the multilayer film defining a mark to be transferred allows this portion to be transferred onto a substrate to be made secure for example by applying pressure notably hot pressure—to the transfer film, without requiring prior cutting of the multilayer film to the dimensions of each mark to be transferred. The inventors have highlighted that such a transfer film may have a total thickness of about 150 microns, or even more, and only allow the transfer of the portions of the multilayer film arranged exactly opposite the adhesive layer without causing crimping at the edges. Each mark to be transferred is according to the invention defined by an adhesive layer portion arranged opposite the multilayer film and corresponding multilayer film portion. The adhesive layer extends according to a format and dimensions smaller than those of the multilayer film such that the portions of the multilayer film opposite the adhesive layer are transferable onto a substrate and define each mark to be transferred.

Moreover, a transfer film according to the invention allows a mark to be transferred onto a substrate to be made secure by means of any type of transfer tool, particularly a hot transfer tool, such as a hot press, with the dimensions of the stamp thereof being larger than or equal to the dimensions of each mark to be transferred. It is not necessary to use a press whose dimensions exactly match the mark to be transferred. A transfer film according to the invention also allows transfer by roller lamination. The pressure exerted by the rollers or the press on the different layers causes a shearing of the intermediate layers arranged between the substrate and the base film at the ends of each adhesive layer portion such that only the portion of the multilayer film arranged opposite the adhesive layer remains on the substrate once the transfer is complete.

The multilayer film carried by the base film may be of any type. It may include a hologram, a diffraction grating, miniature Fresnel prisms etc. Such a multilayer film may include a plurality of layers of varnish, protection, reflective, etc.

To advantage and according to the invention, the multilayer film is constituted by layers applied by printing and/or coating and/or deposition (in liquid or gaseous phase), in other words layers of setting fluid compositions, particularly varnish or metallic layers (and not films made of synthetic material).

The optical layer contains the information for guaranteeing the authenticity of the substrate onto which the marks defined by multilayer film portions come to be transferred.

The releasing layer allows the multilayer film to be totally separated from its base during a transfer. This layer may be of any type. It may be a layer of wax, a layer of silicone or a layer of a material such that the adhesion with the layer immediately below is weaker than the adhesions between the other layers. It is selected with an adhesive power adapted to that of the adhesive layer.

All these intermediate layers undergo during a transfer, through the pressure of the transfer tool, a shearing at the peripheral edge of each portion of the adhesive layer, such that only the portions of the intermediate layers arranged opposite an adhesive layer portion are transferred onto the substrate. The base film arranged opposite the portion of the adhesive layer may be removed by means of the releasing layer.

To advantage and according to the invention, said multilayer film includes at least one layer of varnish for the protection of said embossed and/or metallized image or images.

The layer of varnish for protecting the optical layer allows each embossed and/or metallized image to be protected against chemical and/or thermal attack.

To advantage and according to the invention, said multilayer film includes at least one reflective layer.

A reflective layer enables light rays to be reflected and allows the secured substrate to be inspected by an operator. This reflective layer brings out each embossed and/or metallized pattern of each mark transferred onto the substrate, particularly a transparent embossed pattern.

This reflective layer is preferably a High Reflex Index (HRI) layer. This layer may be implemented by vacuum deposition by evaporation of zinc and/or aluminium sulphide. This reflective layer can increase the natural reflection of light by the optical layer of the multilayer film. The use of zinc sulphide allows the reflective power of the optical layer to be increased by 20% and the use of aluminium allows the reflective power of the optical layer of the multilayer film to be increased by 80%.

The optical layer of the multilayer film according to the invention may include one or more embossed and/or metallized images. These images may be of all types and of all forms.

To advantage and according to the invention, said multilayer film includes a plurality of embossed and/or metallized images.

To advantage and according to the invention, at least one portion of said adhesive layer is arranged exactly opposite at least one embossed and/or metallized image in such a way that the portion of the multilayer film that includes this embossed and/or metallized image forms a mark to be transferred onto said substrate.

A multilayer film including a plurality of embossed and/or metallized images and a transfer film whereof one portion of the adhesive layer is arranged exactly opposite one embossed and/or metallized image allows only the portion of the multilayer film that includes the embossed and/or metallized image to be transferred, particularly by hot transfer, such that only this embossed and/or metallized image is transferable onto a substrate. This means for example that different transfer films can be made for given applications, based on the same multilayer film by arranging the adhesive layer opposite one or other of the images of the multilayer film.

To advantage and according to the invention, said adhesive layer is discontinuous, in other words it consists of at least two unconnected portions.

A transfer film according to the invention includes a multilayer film adapted so that each portion of the multilayer film opposite the adhesive layer, which defines a mark to be transferred, is able to be separated, during a transfer, from the adjacent portions of the multilayer film which are not opposite the adhesive layer.

Preferably, each adhesive layer portion is entirely opposite at least one portion of the multilayer film such that a transfer film according to the invention does not have an adhesive layer portion not opposite a portion of the multilayer film.

To advantage and according to the invention:
for each mark to be transferred, the adhesive layer has at least one outline edge distinct from the peripheral edges of the multilayer film,
the different layers of the multilayer film are cut-free opposite each outline edge of the adhesive layer.

A film according to the invention requires no prior cutting of the different layers of the multilayer film to allow a transfer of a portion of the multilayer film onto a substrate.

To advantage and according to the invention, a reserve supply is arranged opposite the portions of the multilayer film which are not opposite a portion of the adhesive layer.

The adhesive layer may be a thermo-reactivable adhesive layer, in other words one which is activated by the heat, and may be made out of a thermoplastic or thermosetting adhesive. This layer may as an alternative or in combination be a pressure sensitive adhesive (PSA) layer.

Nonetheless, to advantage and according to the invention, said adhesive layer is a thermosetting adhesive layer.

Such an adhesive layer can to advantage ensure that the portion of the multilayer film to be transferred is laid onto the substrate to be made secure. In particular, a thermosetting adhesive layer constitutes an effective protection against attempts to falsify the hot plate, since the adhesive power thereof increases in accordance with the increase in heat applied to it. Furthermore such an adhesive layer has good resistance on paper.

To advantage and according to the invention, said multilayer film is a holographic film, in other words one that includes at least one holographic layer which may be of any type. A holographic layer includes holograms which may be transparent holograms formed by embossing, and/or metallized holograms formed by embossing a layer of varnish coated with a metallized layer. Preferably, transparent holograms are associated with a layer of aluminium and metallized holograms are associated with a layer of zinc sulphide.

A transfer film according to the invention may be between 30 and 160 μm thick.

Nonetheless, to advantage, a transfer film according to the invention is more than 36 μm thick.

A transfer film according to the invention is thick and may be rigid enough not to bend in shape under the effect of its own weight, which makes manipulation and transfer operations easier.

To advantage, a transfer film according to the invention includes a layer of paper and a layer of adhesive adapted to make the layer of paper adhere to the base film so as to rigidify said transfer film.

Such an additional paper layer allows the transfer film to be rigidified which facilitates operations to manipulate the film, and in particular transfer operations, particularly hot transfer operations.

A multilayer film constituted by a holographic film generally includes a base film of the polyester (PET) type used when making the holographic film. A further function of this polyester film is to rigidify the holographic film for the purposes in particular of facilitating manipulation operations. Nonetheless, as an alternative, a transfer film according to the invention is able not to include such a polyester film. The transfer film can be rigidified by a layer of paper receiving the multilayer film for the purposes of facilitating manipulation and transfer operations. Likewise, even for a holographic film equipped with a polyester film and depending on the thickness of this polyester film, the transfer film according to the invention may include at least one additional layer, particularly a paper layer, so as to rigidify the transfer film sufficiently to facilitate manipulation operations and transfer operations.

To advantage and according to the invention, the format and the dimensions of the multilayer film are equal to the dimensions and format of the base film.

This facilitates operations to implement a transfer film according to the invention. Since a transfer film according to the invention allows a portion of the multilayer film to be transferred, it is particularly advantageous to implement a transfer film whereof the base and multilayer films are of equal dimensions and to define the portions of the multilayer film to be transferred only when implementing the adhesive layer.

The invention extends to a method for making a film for transferring at least one mark to be transferred onto at least one substrate to be made secure, each mark to be transferred including at least one embossed and/or metallized pattern.

The invention also concerns a method for making a film for transferring at least one mark to be transferred onto at least one substrate to be made secure, each mark to be transferred including at least one embossed and/or metallized pattern, wherein:
a releasing layer is applied to a base film,
a multilayer film is applied to said releasing layer, said multilayer film including at least one layer, a so-called optical layer, including at least one embossed and/or metallized image,
an adhesive layer is applied on the opposite side from said releasing layer,
   wherein:
the adhesive layer is applied opposite at least one portion of the multilayer film according to a format and dimensions smaller than those of the multilayer film so as to define each mark to be transferred onto said substrate, each portion of the multilayer film opposite the adhesive layer being adapted to separate itself, during a transfer, from the adjacent portions of the multilayer film which are not opposite the adhesive layer,
for each mark to be transferred so defined, at least one portion of the adhesive layer is applied opposite at least one portion of at least one embossed and/or metallized image of said optical layer, each image portion forming a pattern of this mark to be transferred onto said substrate.

A manufacturing method according to the invention allows a film to be made for transferring at least one mark to be transferred onto at least one substrate to be made secure, each mark to be transferred including at least one embossed and/or metallized pattern. Each mark to be transferred is defined by the adhesive layer arranged opposite the multilayer film. The adhesive layer is applied so as to extend according to a format and dimensions smaller than those of the multilayer film such that only the portions of said multilayer film opposite the adhesive layer, and which define each mark of said multilayer film to be transferred onto said substrate, are transferable onto the substrate.

A manufacturing method according to the invention thereby allows a transfer film to be made which does not require a step of cutting the multilayer film to the dimensions of each mark to be transferred. Each mark to be transferred is solely defined and implemented via the adhesive layer.

To advantage and according to the invention, said multilayer film applied to said releasing layer is a holographic film.

To advantage and according to the invention, each adhesive layer applied is a thermosetting adhesive layer.

To advantage, in a method according to the invention, a holographic film is used that is delivered in a reel. Preferably, on this film is affixed a solid area of varnish and the thermosetting adhesive layer. Provision may also be made for inscriptions and/or security devices for example those described in the patents FR 2 840 431, FR 2 793 726, FR 2 867 590, or the like, to be interleaved between the solid area of varnish and the thermosetting adhesive layer.

The invention extends to a method for transferring at least one mark, each mark to be transferred including at least one embossed and/or metallized pattern.

The invention thus concerns a method for transferring at least one mark including at least one embossed and/or metallized pattern onto a substrate to be made secure, characterized in that:
a transfer film according to the invention is selected,
said transfer film is positioned on said substrate in such a way that an adhesive layer portion of said transfer film is opposite the substrate to be made secure,
pressure is exerted on said transfer film in such a way that the portion of said multilayer film opposite said adhesive layer is able to be transferred onto said substrate.

The pressure step may be implemented by any kind of press or by roller lamination. The pressure step may be at hot pressure or cold pressure, in other words at ambient temperature. Nonetheless, to advantage, the adhesive layer of the transfer film is a thermo-reactivable—particularly thermosetting—adhesive layer such that the pressure step is to advantage implemented by hot pressure so as to activate the adhesion of the adhesive layer.

The invention additionally concerns a transfer film, a method for making a transfer film and a transfer method characterized in combination by all or part of the characteristics mentioned above or hereinafter.

Other characteristics, purposes and advantages of the invention will emerge from reading the following description which sets out as a nonrestrictive example an embodiment of the invention, with reference to the appended drawings; in these drawings:

FIG. 1 is a diagrammatic view in cross-section of a portion of film for transferring at least one mark to be transferred onto at least one substrate to be made secure, each mark to be transferred including at least one embossed and/or metallized pattern,

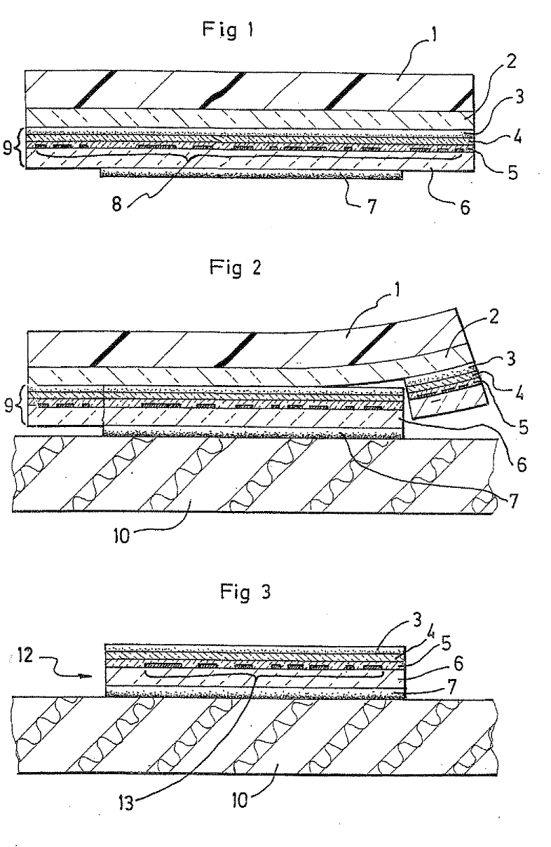

FIG. 2 is a diagrammatic view in cross-section of a film transfer portion in FIG. 1 following transfer onto a substrate to be made secure during peeling of the upper layers,

FIG. 3 is a diagrammatic view in cross-section of a mark transferred onto a substrate from a transfer film according to the invention,

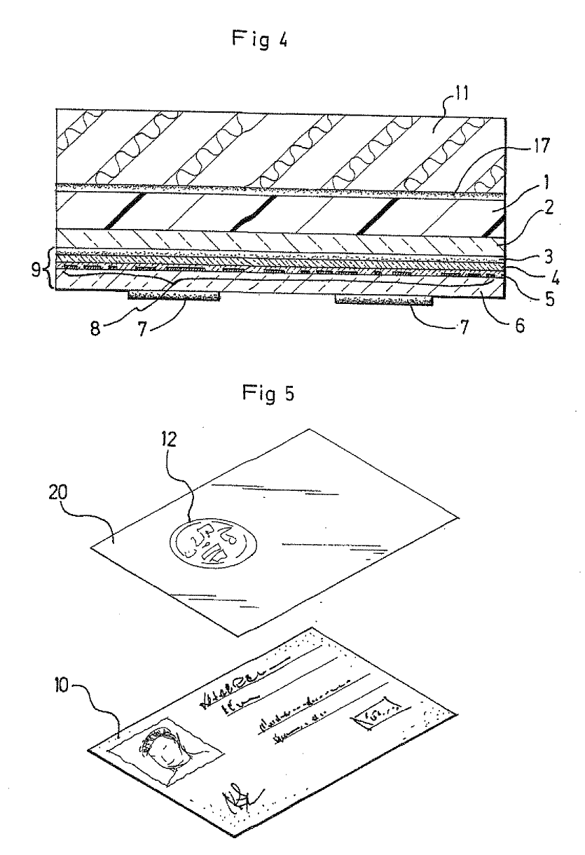

FIG. 4 is a diagrammatic view in cross-section of a transfer film portion according to another embodiment of the invention prior to transfer,

FIG. 5 is a diagrammatic view of an identity document onto which a transfer film according to the invention is to be applied,

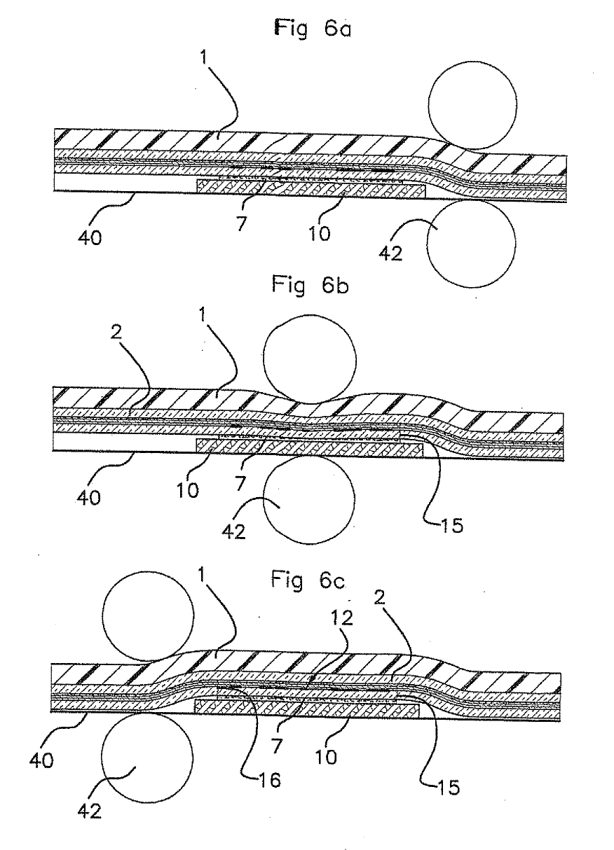

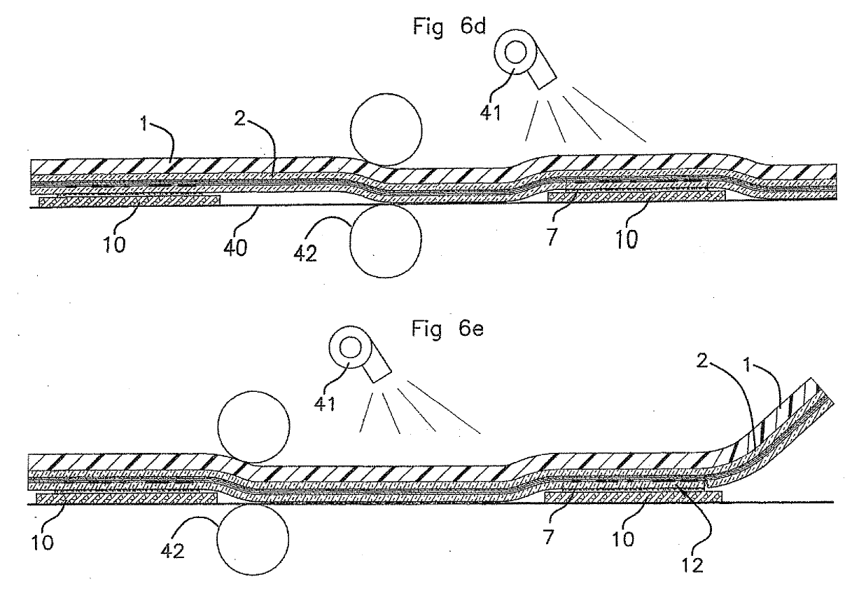

FIGS. 6a to 6c are diagrammatic views in cross-section showing different successive steps in a transfer method according to the invention.

In the figures, scales of thickness are excessively enlarged in the interests of clarity.

FIG. 1 shows one embodiment of a transfer film according to the invention. According to this embodiment, the transfer film includes a base layer 1 which is a polyester PET layer. This base layer 1 is according to this embodiment between 15 μm and 30 μm thick, typically around 19 μm thick.

The transfer film also includes a multilayer film 9 including at least one optical layer 5 including at least one embossed and/or metallized image 8. This multilayer film 9 includes, according to the embodiment in the figures, apart from the optical layer 5, an anti-abrasion layer 3 allowing the abrasion resistance of the multilayer film 9 to be strengthened, a reflective layer 6 and a layer 4 of varnish for protecting the optical layer 5. This multilayer film 9 may be a holographic film which is commercially available in reel form and which has, according to the embodiment in FIG. 1, typically a total thickness of around 4 μm.

The transfer film also includes a releasing layer 2 arranged between the base layer 1 and the multilayer film 9 so as to allow, during a transfer, the separation of the base layer 1 from said multilayer film 9. This releasing layer 2 is preferably a layer of wax but may also be a layer of silicone.

The transfer film also includes an adhesive layer 7 arranged opposite a portion of the multilayer film 9. The dimensions the adhesive layer 7 are smaller than the dimensions of the multilayer film 9 such that only the portion of the multilayer film 9 arranged opposite the adhesive layer 7 can be transferred onto a substrate 10 during a transfer operation. The adhesive layer 7 can be made out of any type of adhesive, cold pressure sensitive or thermo-reactivable, particularly thermoplastic or thermosetting. Nonetheless, preferably, the adhesive layer 7 is made out of a thermosetting adhesive which has an adhesion value above 10N/25 mm measured according to ISO standard 8510-2.

According to the embodiment in FIG. 1, the total thickness of the transfer film is around 155 μm.

According to one advantageous embodiment, as shown in FIG. 4, the transfer film also includes on the base film 1 side, a paper layer 11 and a layer 17 of adhesive arranged between the base film 1 and the paper layer 11 so as to ensure the cohesion of the paper layer 11 with the base film 1. Such a paper layer 11 allows the transfer film so constituted to be rigidified, thereby facilitating manipulation operations and transfer operations, particularly hot transfer operations. Furthermore, FIG. 4 shows an adhesive layer 7 comprising two separate distinct portions, each portion being arranged opposite an embossed image 8. The sum of the dimensions of the adhesive layer 7 portions is less than the dimensions of the multilayer film 9, such that portions of the multilayer film 9 are not coated with an adhesive layer 7 portion and are not therefore transferable onto a substrate 10.

FIG. 2 shows a diagrammatic view in cross-section of the transfer film according to the embodiment in FIG. 1 following transfer, during peeling of the upper layers. The transfer film has been previously hot pressed onto a substrate 10 using a press not shown in the figure. According to another embodiment, the transfer is implemented by lamination by hot rollers. The thermosetting adhesive layer 7 ensures that the transfer film adheres to the substrate 10. The ratios between the adhesion values of the adhesive layer 7 and the internal cohesion values of the different layers allow the layers to break during this transfer at the end of the adhesive layer 7 without crimping. Indeed, the pressure exerted by the rollers or the press on these different layers causes a shearing of these intermediate layers arranged between the substrate 10 and the base film 1 at the ends of the adhesive layer 7 such that only the portion of the multilayer film 9 arranged opposite the adhesive layer 7 remains on the substrate 10 once the transfer is complete. The function of the adhesive layer 7 is on the one hand to allow adhesion between the substrate 10 and the portion of the multilayer film to be transferred, constituting the marks 12 to be transferred, and on the other hand to provide a support and fracture zone in which the intermediate layers will shear when pressure is exerted by a roller or press tool. This is possible since the internal cohesion values of the layer 7 of adhesive are higher than the internal cohesion values of the intermediate layers.

Moreover, the releasing layer 2 allows the separation of the base layer 1 from the rest of the film such that when the transfer is over and the upper layers have been peeled, there remains on the substrate 10, as shown in FIG. 3, the adhesive layer 7, a portion of the reflective layer 6, a portion of the optical layer 5, a portion of the protection layer 4 and a portion of the anti-abrasion layer 3. The portions of each of these layers have dimensions exactly matching the dimensions of the adhesive layer 7. Furthermore, the portion of the optical layer 5 so transferred onto the substrate 10 includes at least one part of an embossed and/or metallized image which constitutes the pattern 13 of the transferred mark 12.

A multilayer transfer film according to the invention can thus be used to protect any document such as identity cards, passports, credit cards, cheques, banknotes, transport tickets, entry tickets, cards giving an entitlement to various services, etc.

FIG. 5 shows a document 10 including data to be made secure. A transfer film 20 according to the invention is to advantage used in order to transfer a mark 12 including at least one pattern embossed on the document 10.

A film according to the invention may be transferred onto such a document for example by using a FISHER SÖHNE mark press of the TRANSLAM 500D type. Preferably, the laying parameters are fixed such that the adhesive side of the press plate is heated to 140° C., the transfer base side of the press plate is heated to 110° C., the duration of lamination is set at about 30 seconds and the pressure is set at 5 bars.

To conduct a transfer according to the invention, a document to be made secure is placed in a siliconed protective device. The press is applied to the document according to the parameters previously described. The document is then left to cool for a few moments. An operator is then able to break one corner of the base film 1 and to unstick it, as shown in FIG. 2. The portions of the adhesive layer 7 and of the multilayer film 9 constituted by portions of the reflective 6, optical 5, protection 4 and anti-abrasion 3 layers matching the holographic authentication pattern arranged opposite the adhesive layer 7 portion, then remain on the substrate 10.

FIGS. 6a to 6e show successive steps in one implementation of the transfer method according to the invention.

Beforehand, a transfer film according to the invention is selected and placed opposite at least one substrate 10 to be made secure.

According to the embodiment in FIGS. 6a to 6e, the transfer film is associated with a conveying chain 40 adapted to carry the substrates 10 onto which at least one mark 12 is transferred.

According to FIGS. 6a to 6e, two hot lamination rollers 42 are arranged on either side of a continuously running conveying chain 40 that carries at least one substrate 10.

FIG. 6a shows a substrate 10 upstream of the rollers 42 opposite which the transfer film is arranged in such a way that at least one adhesive layer 7 portion is opposite at least one portion of the substrate 10. Furthermore, the transfer film is constituted such that this adhesive layer 7 is arranged opposite at least one embossed and/or metallized image 8 portion constituting the pattern 13 of the mark 12 to be transferred onto the substrate 10.

FIG. 6b shows the same substrate 10 and the same transfer film whereof the upstream end of the adhesive layer 7 is pressed by the rollers. In this way, on the one hand, the portion of the adhesive layer 7 ensures that the transfer film adheres to the substrate 10, and on the other hand, the pressure exerted by the rollers 42 on the different layers of the transfer film has caused these intermediate layers to shear opposite the upstream end 15 of the adhesive layer 7 portion. The base layer 1 is not sheared because of its strong internal cohesion. Depending on the internal cohesion of the releasing layer 2, the latter is or is not partly sheared in the area opposite the peripheral edge of the adhesive layer 7. In FIGS. 6a to 6e, the releasing layer 2 is shown without shearing in the interests of clarity.

FIG. 6c shows the same substrate and the same transfer film whereof the downstream end of the adhesive layer 7 is pressed by the rollers 42. As with the effect on the upstream end, this pressure causes shearing of the intermediate layers arranged opposite the downstream end 16 of this adhesive layer 7 portion.

FIG. 6d shows the same substrate 10 and the same transfer film after they have been fully pressed by the rollers 42 during cooling by a cooling device 41.

FIG. 6e shows the substrate 10 and the transfer film after cooling during peeling of the upper layers in such a way that only the mark 12 remains on the substrate. Peeling entails fracturing the sheared ends 15, 16 and releasing the upper layers arranged over the releasing layer 2.

Such a method can to advantage be implemented on a conveying chain so as to ensure an automated transfer of at least one mark including at least one embossed and/or metallized pattern onto each substrate conveyed by the conveying chain.

A transfer film according to the invention, a method for making such a transfer film according to the invention and a transfer method according to the invention thereby allow any type of document to be made secure without recourse to prior art kiss-cutting and trimming steps, and without having to make a specific application plate whose dimensions exactly match the dimensions of the mark to be transferred.

A transfer film according to the invention, particularly a transfer film including a holographic multilayer film, is therefore particularly suitable for protecting documents and offers strong guarantees as to the security and inviolability thereof. In particular, a transfer film according to the invention clan be used to provide protection to the document production line, by automating the hot lamination process in particular.

1-18. (canceled)

19. Film for transferring at least one mark to be transferred onto at least one substrate to be made secure, each mark to be transferred including at least one embossed and/or metallized pattern, this transfer film including:
a base film,
a multilayer film carried by said base film, and including at least one layer, a so-called optical layer including at least one embossed and/or metallized image,
a releasing layer arranged between said base film and said multilayer film for enabling, during a transfer, the base film to be detached from the multilayer film,
an adhesive layer arranged on the opposite side from said releasing layer,
wherein:
the adhesive layer extends opposite at least one portion of the multilayer film according to a format and dimensions smaller than those of the multilayer film and defines each mark to be transferred onto said substrate,
each portion of the multilayer film opposite the adhesive layer is adapted so as to separate itself, during a transfer, from the adjacent portions of the multilayer film which are not opposite the adhesive layer,
for each mark to be transferred so defined, at least one portion of the adhesive layer is arranged opposite at least one portion of at least one embossed and/or metallized image of said optical layer, each image portion forming a pattern of this mark to be transferred onto said substrate.

20. Film as claimed in claim 19, wherein said multilayer film includes at least one layer of varnish for protecting said embossed and/or metallized image(s).

21. Film as claimed in claim 19, wherein said multilayer film includes at least one reflective layer.

22. Film as claimed in claim 19, wherein said multilayer film includes a plurality of embossed and/or metallized images.

23. Film as claimed in claim 22, wherein at least one portion of said adhesive layer is arranged exactly opposite at least one embossed and/or metallized image in such a way that the portion of the multilayer film that includes this embossed and/or metallized image forms a mark to be transferred onto said substrate.

24. Film as claimed in claim 19, wherein said adhesive layer is discontinuous, in other words it consists of at least two unconnected portions.

25. Film as claimed in claim 19, wherein:
for each mark to be transferred, the adhesive layer has at least one outline edge distinct from the peripheral edges of the multilayer film,
the different layers of the multilayer film are cut-free opposite each outline edge of the adhesive film.

26. Film as claimed in claim 19, wherein a reserve supply is arranged opposite the portions of the multilayer film which are not opposite a portion of the adhesive layer.

27. Film as claimed in claim 19, wherein said adhesive layer is a thermo-reactivable—and particularly thermosetting—adhesive layer.

28. Film as claimed in claim 19, wherein said multilayer film is a holographic film.

29. Film as claimed in claim 19, wherein it is more than 36 μm thick.

30. Film as claimed in claim 19, wherein it includes a paper layer and a layer of adhesive adapted to make the paper layer adhere to the base film so as to rigidify said transfer film.

31. Film as claimed in claim 19, wherein the format and the dimensions of the multilayer film are equal to the dimensions and format of the base film.

32. Method for making a film for transferring at least one mark to be transferred onto at least one substrate to be made secure, each mark to be transferred including at least one embossed and/or metallized pattern, wherein:
a releasing layer is applied to a base film,
a multilayer film is applied to said releasing layer, said multilayer film including at least one layer, a so-called optical layer, including at least one embossed and/or metallized image,
an adhesive layer is applied on the opposite side from said releasing layer,
wherein:
the adhesive layer is applied opposite at least one portion of the multilayer film according to a format and dimensions smaller than those of the multilayer film so as to define each mark to be transferred onto said substrate, each portion of the multilayer film opposite the adhesive layer being adapted to separate itself, during a transfer, from the adjacent portions of the multilayer film which are not opposite the adhesive layer,
for each mark to be transferred so defined, at least one portion of the adhesive layer is applied opposite at least one portion of at least one embossed and/or metallized image of said optical layer, each image portion forming a pattern of this mark to be transferred onto said substrate.

33. Method as claimed in claim 32, wherein said multilayer film applied to said releasing layer is a holographic film.

34. Method as claimed in claim 32, wherein said applied adhesive layer is a thermosetting adhesive layer.

35. Method for transferring at least one mark including at least one embossed and/or metallized image onto a substrate to be made secure, wherein:
a transfer film according to claim 19 is selected,
said transfer film is positioned on said substrate in such a way that an adhesive layer portion of said transfer film is opposite the substrate to be made secure,
pressure is exerted on said transfer film in such a way that the portion of said multilayer film opposite said adhesive layer is able to be transferred onto said substrate.

36. Method as claimed in claim 35, wherein:
said substrate on which pressure has been exerted is left to cool,
said releasing layer is peeled in such a way that only the transferred mark(s) remain(s) on said substrate.

37. Method as claimed in claim 33, wherein said applied adhesive layer is a thermosetting adhesive layer.
